(19) United States
(12) Patent Application Publication
(10) Pub. No.: US 2006/0277065 A1
(43) Pub. Date: Dec. 7, 2006

(54) Method for institutionally effecting hand hygiene practices

(76) Inventors: Sharon M. Guten, Beachwood, OH (US); Patricia A. Taylor, New Philadelphia, OH (US); Sonia A. Alemagno, Russell, OH (US); Bruce J. Van Deman, Shaker Heights, OH (US); Christopher B. Gargoline, Stow, OH (US); Dennis L. Gladin, Seven Hills, OH (US)

Correspondence Address: RAY L. WEBER;RENNER, KENNER, GRIEVE, BOBAK, TAYLOR & WEBER, 400 First National Tower, Akron, OH, 44308, US

(21) Appl. No.: 11/146,575

(22) Filed: Jun. 6, 2005

(51) Int. Cl. G06Q 10/00

(52) U.S. Cl. 705/2

(57) ABSTRACT

A method to effect behavioral change with regard to good hand hygiene practices is disclosed. The methodology employs staged and stratified tools of education, triggers of awareness, leadership development, personal engagement, feedback, reinforcement, and the provision of outside support matched to stages of individual and cultural change. The program stages through a pre-launch period, a launch period, a concentrated period of culture change, and a process for maintaining the culture thereafter. Each stage involves various tools and various personnel to achieve the desired result of good hand hygiene practices being a way of life, rather than a weak periodic focus that can threaten safety and quality of patient care.

### TECHNICAL FIELD

The invention herein resides in the art of behavioral management and, more particularly, to the establishment and maintenance of particular behaviors on an institutional-wide basis. More specifically, the invention relates to the establishment and maintenance of good hand hygiene practices in institutional environments.

### BACKGROUND ART

Good hand hygiene practices are a requisite for good health. While personal hand hygiene practices may directly impact the health of an individual, the corporate or institutional practices of individuals associated therewith may greatly impact the health of multitudes of others. It is well known that disease and infection is often communicated from one person to another as a consequence of poor hand hygiene practices by one or more persons in a chain of contact. In the hospitality industry, where employees have contact with food, service ware, bedding and the public, the possibilities for transmitting germs from one person to another are great. Schools, day care centers and offices have similar issues. But, the issue is probably most pronounced in the health care industry itself.

It is believed that hospital acquired infections cause approximately 90,000 deaths per year and nearly one third of these, or 30,000 deaths, are attributable to poor hand hygiene. Indeed, the Centers for Disease Control recognizes improved hand hygiene as a key to substantially reducing hospital or health care acquired infections.

The failure of workers to employ good hand hygiene practices and to comply with standards for hand hygiene results from opposition based in apathy, time pressures, resistance to change and the like. Indeed, there are many excuses for the failure to comply with hand hygiene norms in many key industries and, while the health care industry will be primarily addressed herein, it will be understood that the problems and resultant solutions presented are applicable to a multitude of industries and service organizations.

While the need for good hand hygiene has been well known and documented in the past, there has been an egregious failure to develop and sustain improvement. Past efforts in addressing the problem have typically been superficial, at best, with little attention or effort directed to effecting the behavior and cultural changes necessary to bring about lasting change in an institutional environment. Indeed, as presented herein, only by addressing the issue of hand hygiene on an institutional basis, with a staged and stratified program that provides for assessment and remedial feedback, can an effective lasting change be made.

### DISCLOSURE OF INVENTION

In light of the foregoing, it is a first aspect of the invention to provide a method for institutionally effecting hand hygiene practices that brings about cultural change at the institutional level.

Another aspect of the invention is the provision of a method for institutionally effecting hand hygiene practices that brings about behavioral change at the individual level.

It is yet another aspect of the invention to provide a method for institutionally effecting hand hygiene practices that is staged and stratified to sustain long term individual behavioral and institutional cultural changes. And, further, such a design recognizes that, for effective change to occur, the appropriate tool must be matched with the individual's readiness to change and, accordingly, stage-matched tools have the best probability of inducing-the desired individual and institutional changes.

Still a further aspect of the invention is the provision of a method for institutionally effecting hand hygiene practices that is structured for self evaluation and remedial action, as required.

An additional aspect of the invention is the provision of a method for institutionally effecting hand hygiene practices that is continual in nature to assure maintenance of the cultural and behavioral changes.

Yet a further aspect of the invention is the provision of a method for institutionally effecting hand hygiene practices that is conducive to implementation in an institutional environment with minimal intrusion into normal operation, and at minimal costs.

Still another aspect of the invention is the provision of a method for institutionally effecting hand hygiene practices that provides appropriate tools for both the target (health care worker) and the manager (infection control worker or health educator).

The foregoing and other aspects of the invention, which will become apparent as the detailed description proceeds, are achieved by a method for institutionally effecting hand hygiene practices, comprising: staging specific actions in a specific sequence and at specific times to effect a culture change regarding hand hygiene within an institution; employing stage matched tools appropriate to each of the stages to obtain a desired result in each stage before proceeding to a next sequential stage; assessing the effectiveness of the actions at each stage before proceeding to a next subsequent stage; and remaining in a given stage and undertaking the actions thereof until the assessment of the effectiveness of such actions satisfies a predetermined criteria.

### DESCRIPTION OF DRAWINGS

For a complete understanding of the method of the invention, reference should be made to the following detailed description and accompanying drawings wherein:

FIG. 1 is a topical chart showing the method of the invention and its staged and stratified nature; and

FIG. 2, comprising FIGS. 2A-2E, is a detailed flow diagram of the method of the invention in one implementation thereof.

### BEST MODE FOR CARRYING OUT THE INVENTION

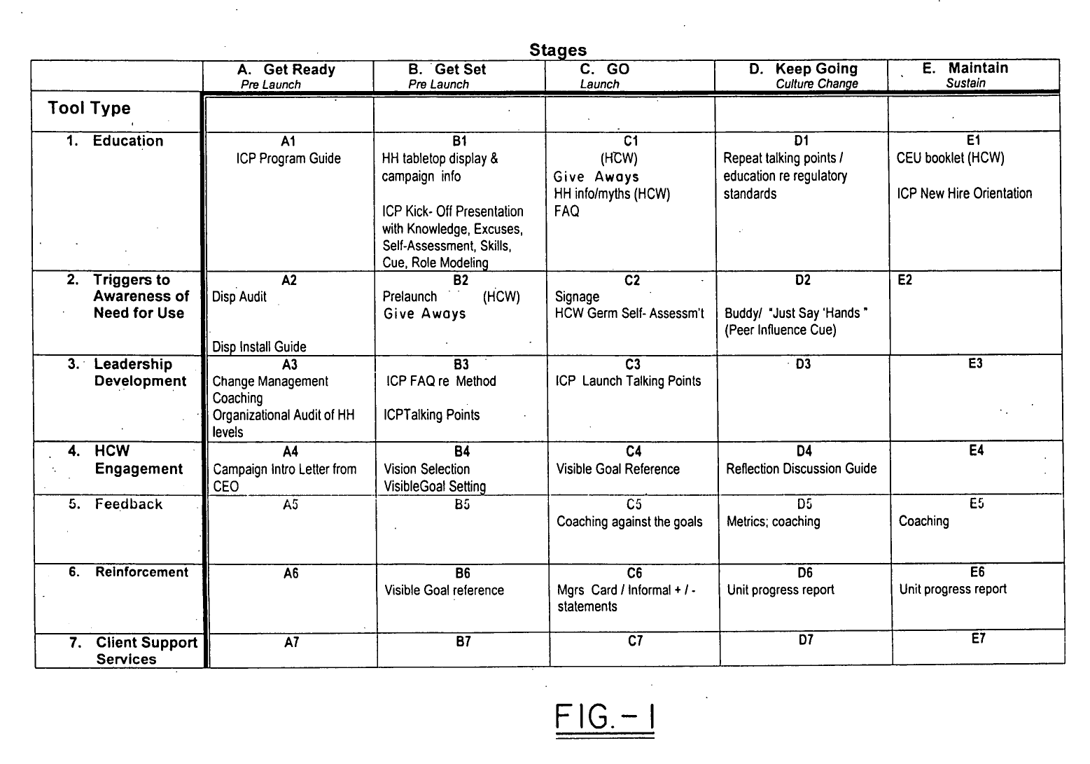

Referring now to the drawings and more particularly FIG. 1, it can be seen that the method of the invention is shown in topical form by the chart of FIG. 1, and designated generally by the numeral 10. As shown, the method is both staged and stratified, being shown as employing five stages, with the stages having particularly associated tools to be employed to effect the desired result at each stage. The stages of the process include pre-pre launch, pre launch, launch, culture change and post launch maintenance, with the tools employed in the various stages consisting of education, triggers to awareness of need for use, leadership development for the institutional manager, health care worker engagement, feedback, reinforcement and client support services.

In the context of the method of the invention, and in the environment of a hospital or health care facility, the program provides for the placement of hand disinfection dispensers filled with alcohol-based hand rub gel solution or the like at various strategic locations about the institution or facility, and the program effects the necessary cultural change to increase the normally low levels of use of such dispensers for improved hand hygiene. While the program and method are set forth in detail with respect to a health care facility, it will be understood that it is equally applicable to any of numerous environments where hand hygiene is of significant importance.

At the commencement of the program, in the pre-pre launch or “get ready” stage, the organizational “change manager” (Infection Control Practitioner (“ICP”) or health educator) of the facility is provided with a program guide which presents an overview of the process, establishing the program with a very brief overview of the stages employed. The purpose of this initial educational step, identified at Al in FIG. 1, is to allow the ICP to obtain an overview of the program with an understanding of what the ICP will need to do during the program. The overview of the process provided at Al is necessarily simple and enlightening, so as to not intimidate the ICP, but rather provide encouragement and enthusiasm, and an early understanding that managing a program to effect behavior change and institutional culture change requires a process mind set.

At A2 in the pre-pre launch stage, an assessment or audit is made of the facility to determine the number of hand disinfection dispensers required and the advantageous locations where they will be mounted or deployed. The ICP is further advised as to the time it will take to effect the installations of the dispensers, when the task will be undertaken, and the nature of anticipated disruptions, if any. In effect, the ICP is advised as to what to expect as the facility or institution is prepared for the program, and how the ICP should prepare for any disruptions or inconveniences. The dispensers are then installed, triggering awareness among the health care workers of their presence, need and use.

Next, at A3, in the pre-pre launch stage, there is an organization or institutional audit of the hand-hygiene levels employed at the facility. In this step, which would typically be undertaken during the first 2-4 weeks following the installation of the dispensers at A2, an assessment is made as to the frequency of use of the dispensers within the institution or facility. The assessment can be made informally as by simple observation, or by employing a counter or the like associated with the dispenser to count the number of dispensing cycles during a given period. This step at A3 provides a baseline for assessment as to the amount of use that the dispensers evoked simply by their presence and accessability, prior to education, motivation and marketing. The period of time during which the monitoring is undertaken also provides the health care workers with the opportunity to familiarize themselves with the presence of the hand disinfection dispensers, as well as eliciting, at least to some extent, their use. Here also, “champions” may be selected as a part of the leadership team to introduce the upcoming change among the health care workers by simple conversations and the like. It is also contemplated that during the A3 stage, the organizational change manager is educated and coached regarding-the details of the program being engaged, its purpose, and the obstacles that might be encountered during its implementation.

Next, a letter of introduction, announcing the institutional campaign to improve hand hygiene practices is sent throughout the organization from a person or persons in upper management. The letter, sent at A4, serves to rally the organizational personnel toward a common goal for the benefit of all, and encourages full participation.

At B1, the program enters its pre-launch stage. Here, the Infection Control Practitioner introduces the health care workers to the importance and benefits of good hand hygiene which, in the preferred embodiment, includes the use of alcohol based hand gels or the like for purposes of hand disinfection. The alcohol based gels are preferred because of their ease of use, superior hand-friendliness, and the absence of any necessity for soaps and towels or the like during the disinfection process. This kick-off presentation, for educating the health care workers, can be as simple as the use of a table set-up with informational pamphlets or brochures and tabletop displays introducing the program and campaign and highlighting its importance and benefits, or as detailed as comprehensive education delivered by means of a CD, DVD, or other media. It is contemplated that the Infection Control Practitioner will here educate the health care workers with regard to acceptable hand hygiene practices and provide initial instructions regarding personal assessment, defuse excuses, dispel myths, and effect peer to peer relations that tend to make good hand hygiene practices the norm. All of this provides education to the health care workers necessary to form a basis for active participation in the program.

At B2, the health care workers are provided with “give away” items that serve to trigger their awareness of the need to sanitize their hands and to comply with professional standards for good hand hygiene. In this regard, the give away items may be as simple as buttons, pins, or personal portable dispensers that may be hung from a belt or the like. Their ever-present nature highlights and reminds the health care workers of the imperative to achieve individual and institutional goals.

Next, at B3, as a part of the leadership development, the ICP is provided with a short list of frequently asked questions and answers, and other talking points that will typically be well received and understood by the health care workers to implement the hand hygiene program. The provision of such frequently asked questions and talking points assists in developing change management leadership competencies in the Infection Control Practitioner, and instilling recognition of the same among the health care workers.

At B4 in the pre-launch stage, continued contact is maintained with the health care workers for purposes of motivating them to attain individual behavioral goals and concomitant institutional cultural goals. Here, a vision selection or mission statement is provided, and a goal is set for the various departments, divisions, and the facility-or institution as a whole. Next, at B6, visible indicia of the goal or goals are provided in the form of banners, posters, screen savers, and the like such that the goals are ever present before the health care workers as a reminder and reinforcement of the goals in the interest of the safety of all concerned.

At this time, the requisite education, motivation and goal-setting are in place for the effective launch of the project. At C1, additional give away items, buttons, or small dispensers of the sanitizer to be hung from the health care worker's person are provided to effect the launch. The ICP further enhances and reinforces the educational aspects of the program by providing information and dispelling frequently held myths regarding hand hygiene, while addressing a multitude of frequently asked questions in that regard. Further triggers to awareness of the need for hand hygiene are effected at C2 by the implementation of signs posted about the health care facility with information about the program being undertaken. Further, each health care worker can be provided with the tools for self assessment of the seriousness of hand hygiene to his/her well being and job performance. For example, a health care worker may simply be advised as to where germs are, what they are, the risks they pose, the exposure to the health care worker, and the like. This trigger of awareness at C2 serves to advise the health care worker of the seriousness of the problem at issue.

Next, at C3, the ICP is provided with the necessary talking points to effect the launch of the program and to demonstrate his/her leadership role. Again, the talking points may be frequently asked questions, reminders to the seriousness of hand hygiene and related issues, or a positive, upbeat message of encouragement.

At C4, the health care workers are again engaged with visible reminders such as posters, placards, screen savers and the like setting forth the vision or mission statement and the desired attainable goals.

Next, at C5, the ICP is provided with the necessary tools to provide feedback to the health care workers for reinforcement and encouragement. When the desired behaviors are performed, it is imperative that they be rewarded to sustain performance. The tools may be nothing more than simple statements such as “great, I just saw you sanitize your hands,” or “I'm sure your patient appreciates the fact you sanitized your hands before touching her.” Finally, in the launch stage, at C6, reinforcement is attained by supervisors and managers being provided with both positive and negative statements that may be used at appropriate times to shape behavior by encouraging and enforcing the rules and processes set forth as a part of the-program.

With the program launched, it now becomes necessary to keep the program going to ultimately effect culture change on an institutional wide basis. As a starting point, education is maintained at D1 by repeating the various talking points, discussing pertinent regulatory standards, and updating the list of frequently asked questions and answers. Here, the ICP seeks to entrench the program as the corporate or cultural norm. Indeed, if the program does not become the norm, it will likely die and, accordingly, reference to the program, and the need for hand hygiene is maintained in staff meetings and woven into the fabric of other programs, where appropriate. At D2, the health care workers are licensed to remind each other of the need for good hand hygiene by simple gestures or hand motions such as simply adopting a discreet hand gesture, or simply saying the word “hands” at appropriate times to remind coworkers of the need to sanitize. At D2, peer influence is employed to trigger and maintain an awareness of the need for good hand hygiene. Further visual indicia may be employed such as decals in various area, on windows, walls, doors and the like. Leadership may be continually developed at D3 by the use of health care publications, articles, regulations and like. The ICP will typically keep herself fully appraised of the developments in the field, to serve as a storehouse of knowledge that may be accessed by the health care workers, and to facilitate such changes to the program as may be necessary.

At D4, frequent reflection and discussion is shared among the various health care workers, the champions of the program, and the ICP to monitor what has happened in the facility to effect culture change and to keep that change intact and ongoing. A key effort in engaging health care workers at this point is to engage all of the health care workers within the fold of compliance, being able to detect and address recalcitrant workers who might seek to deviate from the new norm or take other action that might derail the entire program. At D4, the ICP, champions, and health care workers seek to address and resolve issues and problems.

At D5, coaching continues in response to feedback from health care workers to reinforce the program and ensure enthusiasm with respect thereto. Poster boards, scoreboards, “thermometers,” celebration of success, and the like may be employed throughout the facility to demonstrate the effectiveness of the program and the broad range of the participation therein.

At D6, the ICP prepares a unit progress report with an analysis of what has happened and is happening with regard to culture change respecting hand hygiene in the institution. In order to encourage participation, the progress report is a form report with blank areas to be filled in by the ICP. The report serves to reinforce the program, both with management and the health care workers.

In the final, yet continuing, stage of the method, the culture change effected for the institution is sought to be maintained. At E1, continuing education programs, which may be in the form of brief one hour seminars, are undertaken to prevent a relapse to old bad habits and to maintain the cultural change. New hires are brought into the fold by an attenuated introduction to the hand hygiene program, with encouragement to observe the good hand hygiene practices employed by coworkers in the institution, which constitutes part of the institution's culture. Written materials such as short pamphlets, booklets, brochures or fliers may also be used for educational purposes in maintaining the cultural change at E1.

Highlighting the awareness of the need for continued use in the maintenance arena is undertaken at E2 by the periodic introduction and use of additional given away items, signage and the like to remind the health care workers of the need for good hand hygiene and to reinforce the cultural change. In this regard, the ICP will typically take the lead to demonstrate commitment to the program and the program's sponsor may serve as a consultant to help when problems arise. At E5, the coaching continues as previously described with respect to C5 and D5 to obtain feedback from health care workers and provide assistance and response thereto. Finally, at E6, further periodic progress reports are provided of the general nature set forth at D6 such that the hand hygiene culture of the institution may be maintained and, if deviance is noted, the same may be promptly addressed.

As shown in FIG. 1, each stage of the process 10 ends with a provision for client support services A7-E7. This is to ensure that a subsequent stage of the process is not engaged until the prior stage has been fully effected. To the extent that the requirements of any stage have not been satisfied, aid can be sought from the source supplying or administering the hand hygiene compliance program to resolve any problems or issues before advancing to the next step.

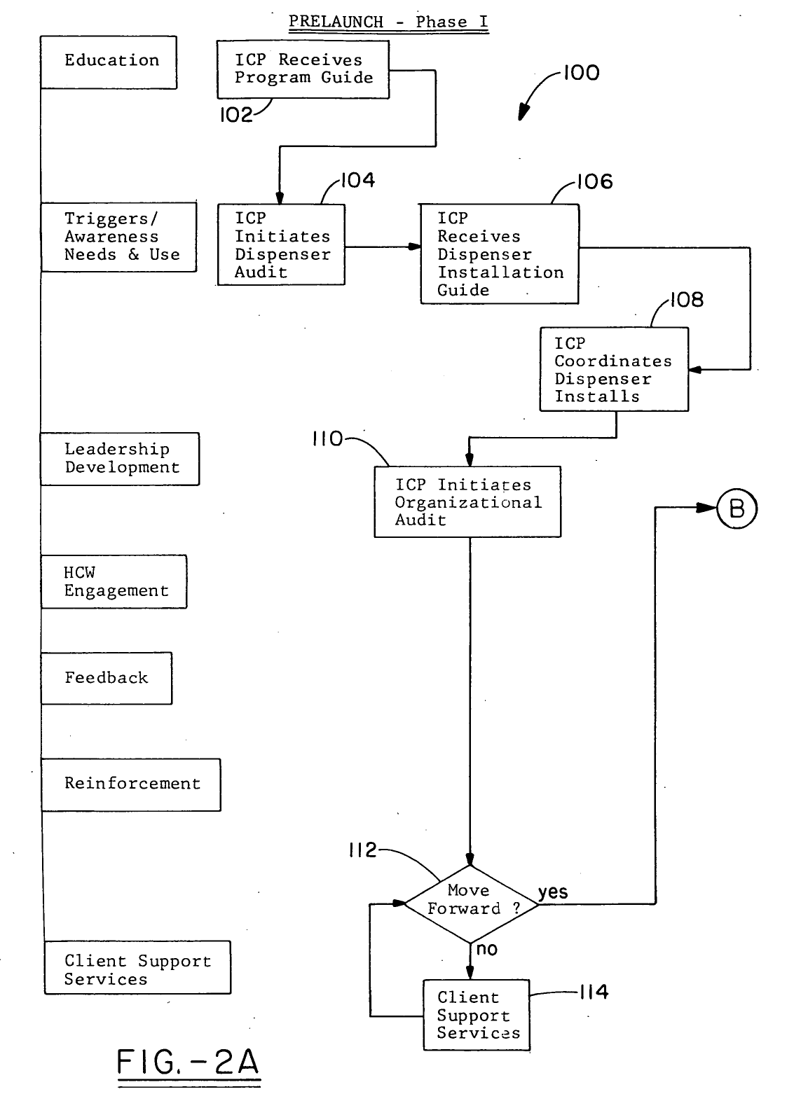

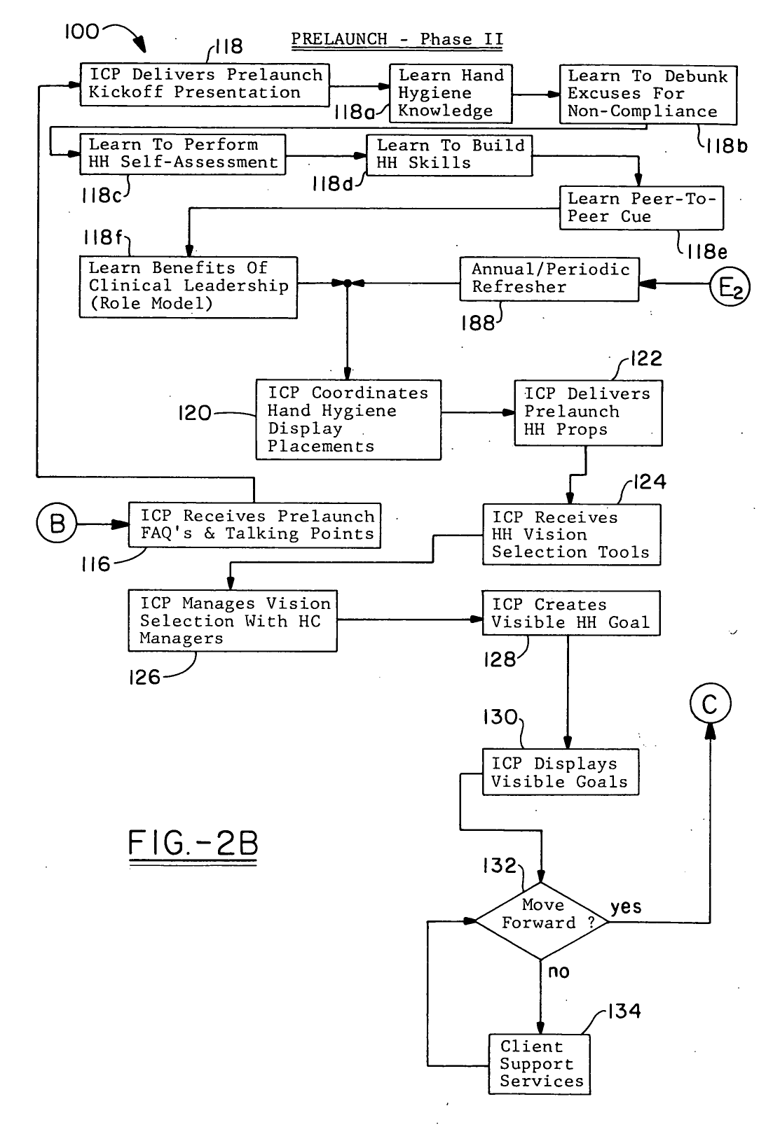

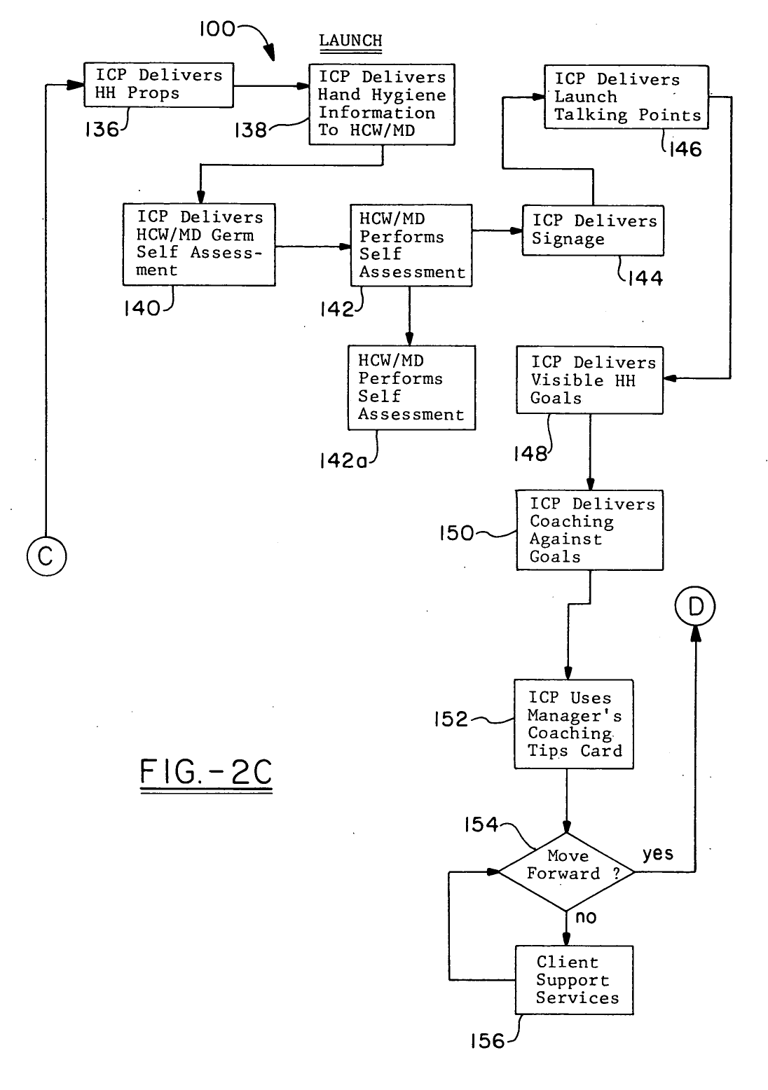

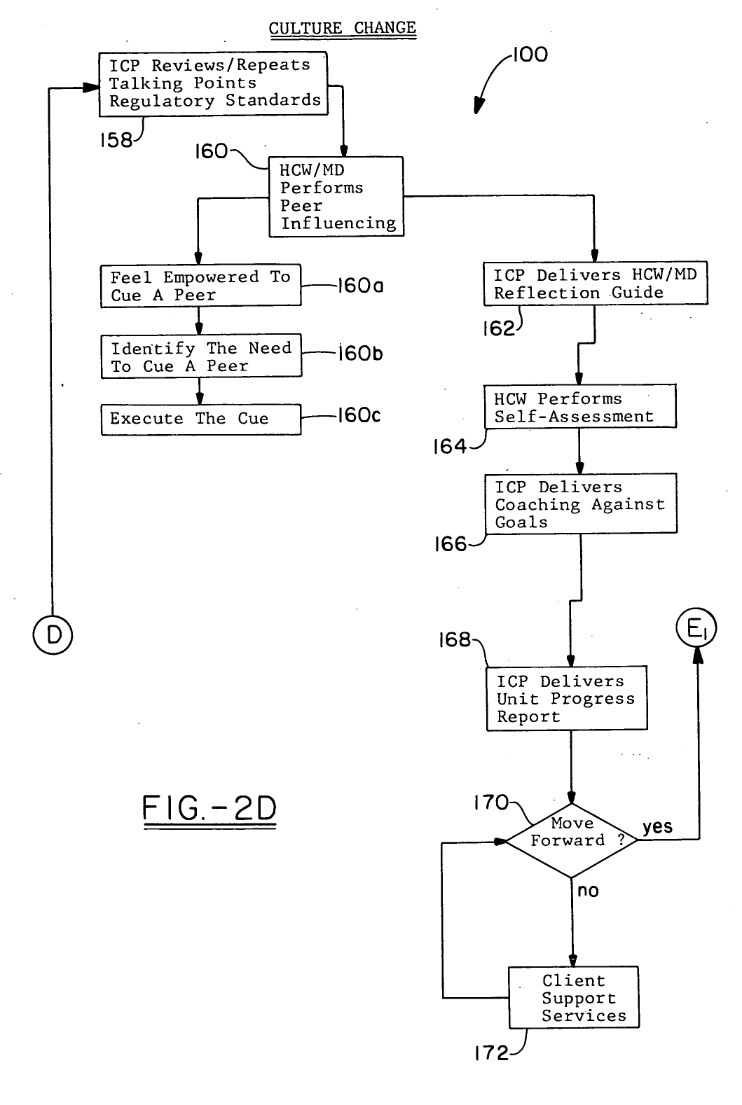

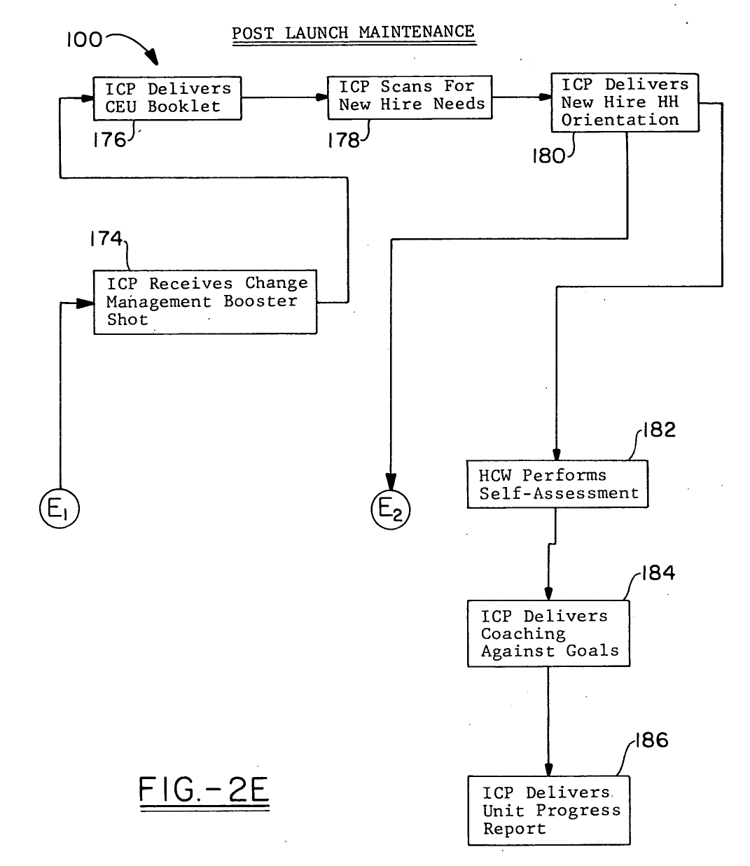

With reference now to FIG. 2, comprising FIGS. 2A-2E, an appreciation of a detailed flow chart of the method and system of the invention can be seen, with the process thereof being designated generally by the numeral 100. The flow chart of FIG. 2 tracks, with enhancements and embellishment, the topical chart of FIG. 1 and is correspondingly staged and stratified. In FIG. 2, the pre-launch stage is set forth in two phases, corresponding to the pre-pre-launch and the pre-launch stages of FIG. 1. It will be noted that FIG. 2A illustrates the strata of tool types employed in the various stages of the method of the invention as extended through FIGS. 2B-2E.

In phase I of the pre-launch stage of FIG. 2A, the ICP receives the program guide at 102, thereby receiving the first informational material relevant to the hand hygiene compliance program. Thereafter, the ICP initiates a dispenser audit at 104, receives and reviews the dispenser installation guide at 106, and coordinates the installation of the dispensers throughout the facilities of the institution at 108. The number and positioning of the dispensers is strategically determined through the audit to effect their most beneficial use to the operation of the institution and the actual usage by health care workers. This installation throughout the facilities triggers awareness of the needs and use of the sanitation dispensers and begins heightening the awareness of the employees for the program that will ensue.

Next, the ICP initiates an organizational audit of the institution at 110, to determine both the current hand-hygiene levels practiced at the institution, as well as the organizational climate for the program to be engaged. As presented earlier, the current hand hygiene levels may be objectively assessed by observation of device monitoring through counters or the like, or simply by subjective assessment through conversations, assessing the frequency of demand for refills, and the like. At this level, leadership competencies for change management are being instilled in the ICP and his/her associates. A determination is then made at 112 as to whether Phase II of the pre-launch stage may be engaged. If, for some reason, complete installation of dispensers has not been achieved or the organizational audit has not been completed, services of others, such as an outside vendor or the like, may be sought at 114 to complete the installation and/or audit. Once so completed, Phase II is entered as at 116 (FIG. 2B), where the ICP is provided with various talking points and frequently asked questions/answers to consummate the pre-launch activities. So prepared, the ICP delivers a pre-launch kick-off presentation as at 118. The presentation may be multifaceted, whereby the ICP impacts knowledge to the health care workers regarding the nature and importance of good hand hygiene practices at 118a, or debunks excuses for poor hand hygiene practices as at 118b. The health care workers may be instructed and learn how to perform self assessments of hand hygiene practices as at 118c, or how to develop hand hygiene skills as at 118d. The ICP may also impart to the health care workers the importance of peer cooperation and participation at 118e, or the benefits of clinical leadership as by role model development at 118f. All of which serves to educate the health care workers as to the form and substance of the program being embarked.

In the pre-launch kick-off presentation, the ICP may employ the use of an educational presentation and hand hygiene display placements such as posters, tabletop displays, and personal give away items and other means such as hand hygiene compliance self-assessment to trigger awareness among the employees as at 120, 122. Again, any of various types of props, posters, displays, self-assessments, personal items or the like may be employed to develop the desired awareness. Next, at 124, the ICP receives the hand hygiene vision selection tools necessary to allow the ICP to target and achieve the desired results regarding hand hygiene practices at the institution. At 126, and 128, the ICP then shares the vision selection or mission statement with the managers of the health care workers of the institution and defines, with visible indicia, the goal or goals to be achieved. The managers and health care workers are so informed to share the vision of the mission statement with those whom they supervise, while the visible indicia such as banners, posters, screen savers and the like, which are developed at 128, are displayed at 130 throughout the facilities to reinforce the vision and mission statement with the health care workers so as to be ever present with them.

A determination is then made at 132 as to whether Phase II of the pre-launch has been successfully completed. If problems are noted, or failure to complete exists, client support services can again be accessed at 134 through an outside source or the like, to complete the procedures of Phase II. Once completed, launch of the program may be effected.

In the launch stage of FIG. 2C, at 136, the ICP delivers hand-hygiene props, such as additional give away items, buttons, small personal dispensers of sanitizer, and the like to the health care workers and, at 138, provides information, regarding both facts and myths, pertaining to hand hygiene and its importance in the role of the facilities involved. This information is provided to all health care workers, at whatever level, including physicians and the like. Following this educational phase of the launch procedure, the ICP seeks to trigger awareness of the needs and use of the alcohol based sanitizing gels to be employed at 140 by requesting of the health care workers, physicians and the like, a self assessment of their hand hygiene practices. The health care workers and physicians undertake this exercise as at 142a and 142b, which not only serves to reinforce the awareness of the needs and use of the sanitizers mounted throughout the facility but also personally engages the health care workers and physicians in the program. Following such self assessment, at 144 the ICP delivers signage to be posted about the health care facility with information about the program being engaged. Next, at 146, the ICP delivers the talking points necessary to effect the launch of the program and to establish the ICP's leadership role. Here, frequently asked questions, messages of encouragement, and reminders of the significance of proper hand hygiene are advanced to those in the facility in the educational portion of the program. During the launch, and following the delivery of such talking points, the ICP delivers the mission statement or vision with visible goals in the form of posters, placards, and the like to engage the health care workers and to maintain the program in an ever present posture throughout the facilities. At 150, the ICP gives feedback to the health care workers and provides the tools, reinforcement and encouragement necessary to achieve success in the program. Here, the ICP gives input to health care workers and appropriately responds, consistent with the goals of the program.

At 152, the ICP receives and uses appropriate statements, gestures, reminders and the like to facilitate his/her encouragement and enforcement of the rules and processes of the program among the health care workers. At 154, a decision is again made as to whether the launch stage of the program has been successful or if any of the stages of educating, triggering awareness, engaging the health care workers, feedback or reinforcement have met with inordinate resistance or failure. If the launch has not been successful, assistance is obtained either internally or from outside source as at 156 to ensure the success of the launch before moving to the final stages of the program.

Once the launch has been successfully made, the next stage of the program 100, shown in FIG. 2D, is to effect culture change at the institution and/or facilities. Here, the ICP continues the education process by repeating the various talking points, discussing regulatory standards, and attending to frequently asked questions/answers at 158. The ICP also encourages the health care workers and physicians to engage in peer influencing to continue to trigger awareness of the need for hand hygiene, as at 160. Various types of triggers for awareness can be employed among peers, including hand gestures, the verbal statement of brief slogans or tag lines to recognize and discourage improper behavior while recognizing and encouraging proper behavior. Simple hand gestures, statements of encouragement, or kind reprimands may be employed from peer to peer as at 160 in order to effect the desired culture change.

The importance of peer influencing can not be overstated. At 160a, the health care worker, whether an orderly or medical doctor, is empowered to cue all other health care workers, consistent with the hand hygiene program. The health care workers recognize or appreciate the circumstances or situations giving rise to the need to cue or remind fellow health care workers to sanitize or disinfect, as at 160b. Finally, as a part of the institutional culture change, the health care workers then effect or execute the cue or reminder at 160c.

At 162, the ICP provides the health care workers and physicians with a reflection guide so that all participants can observe and reflect upon the cultural change occurring at the facility, and the positive effects thereof. Here, the health care workers themselves are directly engaged in the concept and charged with its success.

At 164, the health care workers perform self assessment of their performance in effecting culture change, not only by assessing their own hand hygiene practices, but also their participation in recognizing the need to cue peers, and actually undertaking the cue. The self assessment may be a simple questionnaire or check list.

At 166 the ICP continues to coach management, champions of the program, and health care workers to reinforce the program and maintain enthusiasm regarding the same. Here, poster boards and “yard sticks” may be employed throughout the facility to evidence the efficacy of the program and the broad range of participants involved. Next, at 168, the ICP provides a unit or facility progress report with an analysis of the ongoing change at the facility regarding hand hygiene. The report seeks to reinforce the program with both management and health care workers, and to demonstrate the degree of success attained in return for the effort expended.

At 170 a determination is made as to whether the culture change has been effected. If not, support may be sought at 172, from either an outside source or provider, or an internal support service. In either event, only after the culture change has been effected, does the program proceed to the maintenance stage, commencing at 174 of FIG. 2E, where the ICP is further provided with material necessary to maintain the changed culture at the facility. This material is used by the ICP as at 176 in the form of a continuing education booklet that assists the ICP in not only maintaining a good hand hygiene environment, but responding to and implementing changes in the program, if required. At 178, the ICP monitors the presence of new employees at the facilities such that their needs can be assessed at 180 and such that the new hires can, with minimal effort, be brought into the culture of the facilities regarding hand hygiene. It will be appreciated that the presence of the culture itself has an educational benefit on new employees. In other words, in an environment where virtually all of the health care workers and physicians practice good hand hygiene, it is most likely that a new hire will adopt those practices and engage in the practices so observed.

In further maintaining the culture that has been effected, the ICP continues to perform self assessments as at 182, and to coach and assist both management and the health care workers and physicians to reinforce and encourage the maintenance of the culture change that has been effected by the use of simple statements, gestures, posters, placards, and other reminders of the importance of hand hygiene and the culture of the facility with respect thereto as at 184. Finally, at 186, the ICP delivers unit progress reports on periodic bases to keep management of the facilities fully informed as to the condition of the culture and areas thereof requiring attention.

The process of the invention further contemplates periodic refreshers, on an attenuated basis, of the process that effected the culture change. As shown at 188 in Phase II (FIG. 2B) of pre-launch, a substantial portion of the process can be revisited on an annual or other periodic basis, but in an attenuated or accelerated fashion, depending upon the needs of the facility and the state of the hand hygiene culture thereat. This refresher tracks, to varying degrees, substantially all of Phase II of the pre-launch stage, and all of the launch, culture change, and post launch maintenance phases. Each such refresher has the facets of education, triggers as to awareness, needs and use, leadership development, health care worker engagement, feedback, reinforcement, and client support services, as required. Each ends up with a unit progress report as at 186.

It should now be appreciated that the process of the invention not only serves to make health care workers, or similar workers in other industries, aware of the need for good hand hygiene practices, but also effects a culture change at the impacted facility such that good hand hygiene is not simply a periodic focus, but a way of life at the facility. The program employs methodologies to effect individual behavioral change, by increasing the competencies of the infection control practitioner to effect change management, provides for periodic assessments, feedback and program modifications, and does so in a manner that engages all of the participants in a team effort to reach the desired goal.

Thus it can be seen that the objects of the invention have been satisfied by the process presented above. While in accordance with the patent statutes only the best mode and preferred embodiment of the invention has been presented and described in detail, and only with respect to the health care industry, the invention is not limited thereto or thereby. Accordingly, for an appreciation of the true scope and breadth of the invention reference should be made to the following claims.

What is claimed is:

1. A method for institutionally effecting hand hygiene practices, comprising:
staging specific actions in a specific sequence and at specific times to effect a culture change regarding hand hygiene within an institution;
employing stage matched tools appropriate to each of the stages to obtain a desired result in each stage before proceeding to a next sequential stage;
assessing the effectiveness of the actions at each stage before proceeding to a next subsequent stage; and
remaining in a given stage and undertaking the actions thereof until the assessment of the effectiveness of such actions satisfies a predetermined criteria.

2. The method of institutionally effecting hand hygiene practices as recited in claim 1, wherein said stages comprise pre-launch, launch, culture change and maintenance stages.

3. The method of institutionally effecting hand hygiene practices as recited in claim 2, wherein the tools employed at various of said stages comprise education, triggers to awareness, leadership development, engagement of employees, feedback and reinforcement.

4. The method of institutionally effecting hand hygiene practices as recited in claim 3, wherein the pre-launch stage includes the step of assessing the number and location of sanitation dispensers to be installed in a given facility, and thereafter installing such dispensers, thereby triggering awareness among employees of sanitation devices and the ability to sanitize.

5. The method of institutionally effecting hand hygiene practices as recited in claim 4, wherein said pre-launch stage further comprises the employment of visual displays to educate and trigger awareness, physical examples of sanitation product, the establishment of a mission statement for the method, and the development of frequently asked questions and answers regarding hand hygiene.

6. The method of institutionally effecting hand hygiene practices as recited in claim 5, wherein the launch stage comprises further triggers to awareness through signage and self-assessment of hand hygiene practices and the consequences thereof, and the posting of a visible mission statement.

7. The method of institutionally effecting hand hygiene practices as recited in claim 6, wherein the culture changes stage comprises the utilization of peer influence and establishment of a norm that makes it acceptable for peers to influence each other such as the use of preset gestures, slogans, and remarks to trigger awareness and remind peers of the need for good hand hygiene practices.

8. The method of institutionally effecting hand hygiene practices as recited in claim 7, wherein the culture change stage empowers each individual in a peer group to cue all others within that group, regardless of status, of the immediate need for good hand hygiene practices.

9. The method of institutionally effecting hand hygiene practices as recited in claim 8, wherein the culture change stage conditions peers to recognize circumstances giving rise to the need to cue others of the immediate need for good hand hygiene practices.

10. The method of institutionally effecting hand hygiene practices as recited in claim 7, wherein each of the launch, culture change, and maintenance stages comprises coaching of employees for reinforcement and encouragement to effect behavior change and maintenance regarding hand hygiene, and receiving and responding to feedback from such employees with prepared statements and presentations.

11. The method of institutionally effecting hand hygiene practices as recited in claim 10, wherein each of the culture change and maintenance stages comprises a progress report on effectiveness of the culture change and remedial actions in the event that the culture change is not effected.

12. The method of institutionally effecting hand hygiene practices as recited in claim 10, wherein each of the pre-launch, launch and culture change stages comprises an effectiveness assessment at the end thereof, and provision for remedial action through the steps of the associated stage in the event a stage does not satisfy the effectiveness assessment.

13. The method of institutionally effecting hand hygiene practices as recited in claim 12, further comprising steps for effecting behavior modification of new employees to be consistent with the effected culture change of the institution.

14. The method of institutionally effecting hand hygiene practices as recited in claim 13, further comprising the step of periodic refreshing and re-engagement of the stages that effected culture change regarding hand hygiene.

15. The method of institutionally effecting hand hygiene practices as recited in claim 3, wherein said tool of education first provides education regarding the method itself, followed by progressively in depth education regarding the need for and benefits derived from good hand hygiene practices.

16. The method of institutionally effecting hand hygiene practices as recited in claim 15, wherein said tool of triggers to awareness first provides for the installation of hand disinfection dispensers within the institution, followed by physical samples, signage, and peer influence.

17. The method of institutionally effecting hand hygiene practices as recited in claim 16, wherein said tool of leadership development provides leaders at various levels with talking points and responses to frequently asked questions.

18. The method of institutionally effecting hand hygiene practices as recited in claim 17, wherein the tool of engagement of employees comprises the setting of visible goals and the motivating of employees through discussions.

19. The method of institutionally effecting hand hygiene practices as recited in claim 18, wherein the tool of feedback comprises the coaching of employees to achieve said goals.

20. The method of institutionally effecting hand hygiene practices as recited in claim 19, wherein the tool of reinforcement comprises the preparation of unit progress reports and behavior shaping statements and comments to employees.
